(19) United States
(12) Patent Application Publication
(10) Pub. No.: US 2023/0395989 A1
(43) Pub. Date: Dec. 7, 2023

(54) FUNCTIONALIZED HONEYCOMB STRUCTURE, SANDWICH COMPOSITE STRUCTURE, MANUFACTURING METHOD, OPTIMIZATION METHOD AND ASSOCIATED DEVICES

(71) Applicants: NAVAL GROUP, PARIS (FR); UNIVERSITE DE RENNES, RENNES (FR); SERIBASE Industrie, CHATEAU-GONTIER-SUR-MAYENNE (FR); Centre national de la recherche scientifique, PARIS (FR)

(72) Inventors: Mohamed HIMDI, RENNES CEDEX (FR); Raimi BEN DEWAN, RENNES CEDEX (FR); Xavier CASTEL, RENNES CEDEX (FR); Patrick CALDAMONE, CHATEAU GONTIER (FR); Thierry LEVAVASSEUR, CHATEAU GONTIER (FR); Frédéric GOURMELEN, LORIENT CEDEX (FR); Patrick PARNEIX, BOUGUENAIS (FR)

(21) Appl. No.: 18/249,893

(22) PCT Filed: Oct. 21, 2021
(86) PCT No.: PCT/EP2021/079256

§ 371 Date: Apr. 20, 2023

(30) Foreign Application Priority Data
Oct. 21, 2020 (FR) FR2010790

(51) Int. Cl. H01Q 17/00

(52) U.S. Cl. CPC H01Q 17/008; H01Q 17/007

(57) ABSTRACT

Disclosed is an absorbent structure which is a honeycomb structure extending between two end faces and which includes tubular cells, each cell having walls delimiting the cell, the walls extending between the two end faces, the walls being formed from a dielectric material, at least one cell having at least one strip of electrically conductive coating arranged in at least one wall or over a surface of at least one wall, the honeycomb structure being characterized by parameters chosen so that the absorbent structure provides an attenuation of at least 10 dB for each incident wave in a frequency range having a frequency spread greater than or equal to 15 GHz.

### FIELD OF THE INVENTION

The present invention relates to the radio frequency functionalization of composite structural elements integrating core elements in the form of a honeycomb, in order to impart different functions to same, e.g. absorbing, communicating, reflecting and/or focusing electromagnetic waves functions. The present invention further relates to related methods and devices, including a manufacturing method, an optimization method, a composite structure, a computer program product, and a readable storage medium.

### BACKGROUND TO THE INVENTION

Whether in maritime, rail or air transport, the connectivity needs of the vehicles and carriers used (mobile or static) are increasingly important. The above involves the use of devices which interact with the electromagnetic environment such as antennas, absorbing devices, electromagnetic shielding devices, reflectors or lenses that become more and more efficient.

Such performance is generally accompanied by an increase in the weight of such devices and the complexity of the integration of the devices into the vehicle or the carrier.

More particularly, it is known how to add additional appendages to the vehicle or to the carrier in order to position the devices.

However, when aerodynamic character is concerned, the increase in weight and the addition of additional appendages have a very negative impact on the aerodynamics and capacities of the carriers.

### SUMMARY OF THE INVENTION

There is thus a need for devices suitable for interacting with electromagnetic waves which can be better integrated into a carrier.

To this end, the description describes an absorbent structure, the absorbent structure being a honeycomb structure extending between a first end face and a second end face, the honeycomb structure comprising a plurality of tubular cells, each cell including a plurality of walls delimiting said cell, the walls extending from the first end face to the second end face, the walls being formed from a dielectric material, at least one cell having at least one strip of electrically conductive coating arranged in at least one wall or over a surface of at least one wall, the honeycomb structure being characterized by parameters, the parameters of the honeycomb structure being chosen so that the absorbent structure provides an attenuation of at least 10 dB for each incident wave in a frequency range having a frequency spread greater than or equal to 15 GHz.

According to particular embodiments, the antenna has one or a plurality of the following features, taken individually or according to all technically possible combinations:
the parameters are the dielectric and geometric parameters of each cell and the electrical and geometric parameters of each strip.
the at least one cell includes two separate coating strips with a distinct resistance per square.
when the wall of the cell is crossed along in a direction perpendicular to the plane parallel to at least one of the two end faces, the variation in the resistance per square of the strips is strictly monotonic.
when the cell wall is crossed along in a direction perpendicular to the plane, the resistance per square of two adjacent strips differs by an interval of resistance per square comprised between 10 Ohms/sq and 500 Ohms/sq, preferentially between 50 Ohms/sq and 150 Ohms/sq.
at least one strip has a height, said height varying along a direction perpendicular to the plane.
the width of the strip varies according to a variation in stair-steps or according to a strictly monotonous variation along a direction perpendicular to the plane.
the space between two adjacent strips is comprised between 100 micrometers and 1000 micrometers, preferentially between 400 micrometers and 600 micrometers.
the height of the wall along a direction perpendicular to the plane is comprised between 5 millimeters and 50 millimeters, preferentially between 7 millimeters and 25 millimeters.

The description further relates to a sandwich composite structure comprising a core interposed between a first skin and a second skin, said core including at least one absorbent structure such as described above.

The description further describes a method for manufacturing an absorbent structure, the absorbent structure being a honeycomb structure, the honeycomb structure being characterized by parameters, the parameters being chosen so that the absorbent structure provides an attenuation of at least 10 dB for each incident wave in a frequency range with a frequency spread of greater than or equal to 15 GHz, the process comprising the steps of printing strips of electrically conductive coating, depositing a layer of adhesive over a surface of at least one wafer of dielectric material, bonding the wafers to the layers of adhesive, assembling the strips to form a plurality of tubular cells, each cell including a plurality of walls delimiting said cell, the walls extending from a first end face to a second end face of the honeycomb structure extending between a first end face and a second end face, for expanding the assembled wafers, so as to obtain a structure to be set, and curing of the structure to be set, so as to obtain the final absorbent structure.

The description further relates to a method for optimizing an absorbent structure, the absorbent structure being a honeycomb structure extending between a first end face and a second end face, the honeycomb structure comprising a plurality of tubular cells, each cell including a plurality of walls delimiting said cell, the walls extending from the first end face to the second end face, the walls being formed from a dielectric material, at least one cell having at least one strip of electrically conductive coating arranged in at least one wall or over a surface of at least one wall, the honeycomb structure being characterized by parameters, the method including a step of choosing initial parameters for the honeycomb structure, and a step of optimizing the parameters of the honeycomb structure according to an optimization technique implemented by successive iterations on current sets of parameters, the first parameter set being the set of initial parameters and the set of parameters of an iteration being the set of parameters obtained at the previous iteration, the optimization technique being implemented under the requirement that the absorbent structure provides an attenuation of at least 10 dB for each incident wave in a frequency range having a frequency spread greater than or equal to 15 GHz.

The description further relates to a radio frequency lens comprising a plurality of conductive studs, each stud being a honeycomb assembly including at least one tubular cell, each cell including a plurality of walls delimiting said cell, the walls extending from a first end face to a second end face, the walls being made from a dielectric material, at least one cell having at least one electrically conductive coating strip arranged in at least one wall or over a surface of at least one wall, each cell assembly having parameters, the parameters of each honeycomb assembly being chosen so that the radio frequency lens exhibits a predefined spatial variation of effective refractive index.

According to particular embodiments, the radio frequency lens has one or a plurality of the following features, taken individually or according to all technically possible combinations:
the lens has a center and the spatial variation of the effective refractive index corresponds to a gradient from the center of the lens.
the studs are distributed in a plurality zones, the parameters of the honeycomb assemblies of the same zone being identical.
the zones are concentric.
the parameters of each honeycomb assembly are chosen so that the lens has a gain greater than 5 dBi over a range from 8 GigaHertz to 12 GigaHertz.
the parameters of each honeycomb assembly are the dielectric and geometric parameters of each cell and the electrical and geometric parameters of each strip

The description further describes a method for manufacturing a radio frequency lens comprising a plurality of conductive studs, each stud being a honeycomb assembly, each honeycomb assembly having parameters, the parameters being chosen so that the radio frequency lens exhibits a predefined spatial variation of effective refractive index, the method comprising, for each stud, the steps of printing strips of electrically conductive coating, depositing a layer of adhesive over a surface of at least one strip of dielectric material, bonding the strips to the layers of adhesive, assembling the strips to form a plurality of tubular cells, each cell including a plurality of walls defining said cell, the walls extending from a first end face to a second end face of the honeycomb structure extending between a first end face and a second end face, of the expansion of the assembled wafers, so as to obtain a structure to be stiffen, and for curing the structure to be stiffened, so as to obtain the final radio frequency lens.

The description further relates to a method for optimizing a radio frequency lens comprising a plurality of conductive studs, each stud being a honeycomb assembly including at least one tubular cell, each cell comprising a plurality of walls delimiting said cell, the walls extending from a first end face to a second end face, the walls being made from a dielectric material, at least one cell having at least one electrically conductive coating strip arranged in at least one wall or over a surface of at least one wall, each cell assembly having parameters, the method including a step of choosing initial parameters for the radio frequency lens, and a step of optimizing the parameters of each honeycomb assembly according to an optimization technique implemented by successive iterations on current sets of parameters, the first set of parameters being the set of initial parameters and the set of parameters of an iteration being the set of parameters obtained at the previous iteration, the optimization technique being implemented under the requirement that the radio frequency lens exhibits a predefined spatial variation of effective refractive index.

The description further relates to an antenna system comprising at least one part which is a honeycomb structure extending between a first end face and a second end face, the honeycomb structure comprising a plurality of tubular cells, each cell having a plurality of walls delimiting the cell, the walls extending from the first end face to the second end face, the walls being formed from a dielectric material, at least one cell with at least one electrically conductive coating strip arranged in at least one wall or over a surface of at least one wall, the plurality of walls being transparent, the part of the antenna system having parameters, the parameters being chosen so that the antenna system has an optical transmittance of at least 80% for an electromagnetic wave belonging to the visible range and having an incidence substantially normal to a plane parallel to at least one of the two end faces.

According to particular embodiments, the antenna system has one or a plurality of the following features, taken individually or according to all technically possible combinations:
the parameters are the dielectric and geometric parameters of each cell and the electrical and geometric parameters of each strip.
the part of the antenna system is chosen from among an antenna and a reflector plane.
the antenna system is chosen from a wire antenna, a patch antenna and a reflector plane antenna.
the antenna system further comprises an additional strip of electrically conductive coating arranged in at least one wall or over a surface of at least one wall, the supplementary strip being arranged between the at least one coating strip and an end face so as to form a ground plane and/or a reflector plane for the antenna system.
at least one strip has a defined height for each cell, said height of the strip varying between 10 micrometers and the height of the cell including the wall wherein or on which the strip is arranged, said height of the strip preferentially varying between 10 micrometers and 500 micrometers.
the part has parameters, the parameters being chosen so that the antenna system has a desired radiation pattern.
the radiation pattern is such that each cell in combination with the other cells of the plurality has a sector radiation due to the feed of the antenna elements according to a cardinal sine law.

The description further describes a method for manufacturing an antenna system comprising at least one part which is a honeycomb structure extending between a first end face and a second end face, the part of the antenna system having parameters, the parameters being chosen so that the antenna system has an optical transmittance of at least 80% for an electromagnetic wave belonging to the visible range and having an incidence substantially normal to the first ground, the method comprising, for each stud, the steps of printing strips of electrically conductive coating, depositing a layer of adhesive over a surface of at least one wafer of dielectric material, bonding the wafers over the layers of adhesive, assembling the wafers to form a plurality of tubular cells, each cell including a plurality of walls delimiting said cell, the walls extending from a first end face to a second end face of the honeycomb structure extending between a first end face and a second end face, for expanding the assembled wafers, so to obtain a structure to be stiffened, and curing of the structure to be stiffened, so as to obtain the final antenna system.

The description further relates to a method for optimizing an antenna system comprising at least one part which is a honeycomb structure extending between a first end face and a second end face, the part of antenna system having parameters, the parameters being chosen so that the antenna system has an optical transmittance of at least 80% for an electromagnetic wave belonging to the visible range and having an incidence substantially normal to a plane parallel to at least one of the two end faces, the method including a step of choosing initial parameters for the part of antenna system, and optimizing the parameters of the part of antenna system according to an optimization technique implemented by successive iterations on current sets of parameters, the first set of parameters being the set of initial parameters and the set of parameters of an iteration being the set of parameters obtained at the previous iteration, the optimization technique being implemented under the requirement that a part of the antenna system has an optical transmittance of at least 80% for an electromagnetic wave belonging to the visible range and having an incidence substantially normal to a plane parallel to at least one of the two end faces.

The description further relates to a computer program product including a readable storage medium, on which is stored a computer program comprising program instructions, the computer program being loadable on a data processing unit and implementing an optimization method according to the claim when the computer program is implemented on the data processing unit.

The description further relates to a readable storage medium comprising program instructions forming a computer program, the computer program being loadable on a data processing unit and implementing an optimization method as described hereinabove when the computer program is implemented on the data processing unit.

In the present description, the expression “suitable for” means equally well “apt to” or “configured for”.

### BRIEF DESCRIPTION OF FIGURES

The features and advantages of the invention will appear upon reading the following description, given only as a an example, but not limited to, and making reference to the enclosed drawings, wherein:

FIG. 1 is a schematic three-dimensional representation of honeycomb structure,

FIG. 2 is a schematic top view of a cell of a honeycomb structure,

FIG. 3 is a schematic representation in an enlarged three-dimensional view of a wall element of a cell of a honeycomb structure,

FIGS. 4 to 11 are figures obtained during experiments on absorbent structures including a honeycomb structure like the structures shown in FIGS. 1 to 3,

FIGS. 12 to 17 are figures obtained during experiments on radio frequency lenses including a honeycomb structure like the structures shown in FIGS. 1 to 3, and

FIGS. 18 to 26 are figures obtained during experiments on antenna systems including a honeycomb structure like the structures shown in FIGS. 1 to 3.

### DETAILED DESCRIPTION OF PREFERRED EMBODIMENTS

All the devices interacting with electromagnetic waves which will be described hereinafter have a common point: same are all made at least in part on the basis of the same structure, called the basic structure.

Indeed, the applicant has found that a specific basic structure is very advantageous for devices interacting with electromagnetic waves. Such basic structure is a honeycomb structure which is presented first.

In a second step, the interest of the honeycomb structure is shown for three distinct devices: an absorbent structure, a part of an antenna system and a radio frequency lens.

Honeycomb Structure

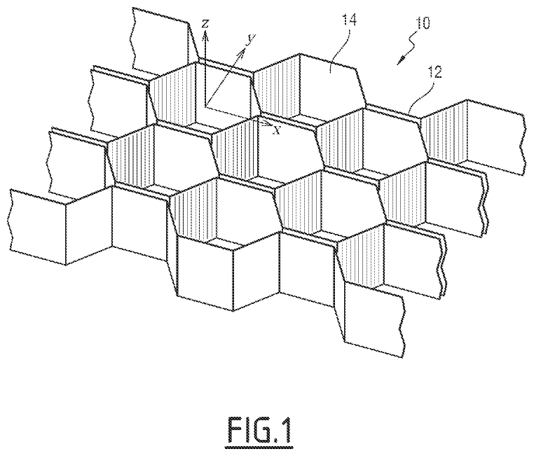

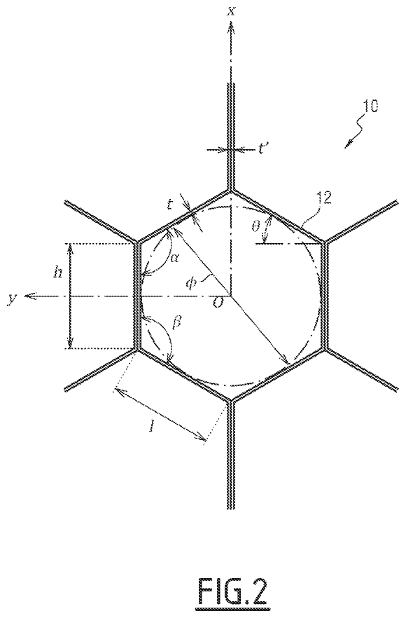

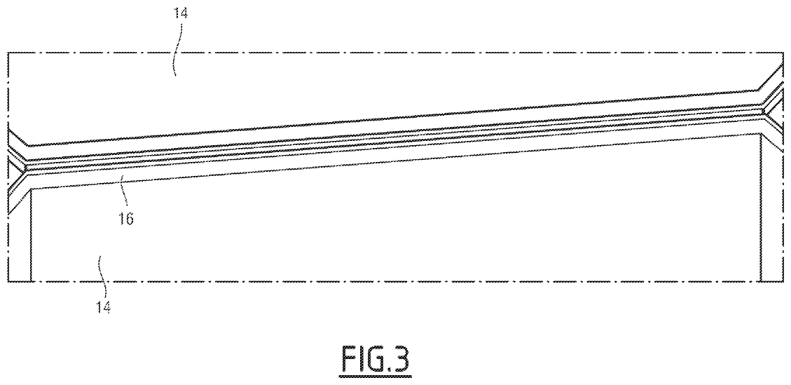

A honeycomb structure 10 is shown in FIGS. 1 to 3. FIG. 1 is a three-dimensional representation. FIG. 2 is a plan view of part of the honeycomb structure and FIG. 3 is an enlarged three-dimensional view of another part of the honeycomb structure 10.

The honeycomb structure 10 is honeycomb or ‘nida’, both terms being equivalent.

The honeycomb structure 10 extends between a first end face and a second end face, not shown in FIG. 1, to make the interior of the honeycomb structure 10 visible.

According to the example proposed, the end faces are assumed to be parallel but this is not mandatory.

When the honeycomb structure 10 is mounted as a core interposed between two skins, the entire honeycomb structure 10 and skins form a sandwich composite structure.

In the example proposed, the first and second end faces are intended for being arranged so as to extend in planes parallel to the skins. The first and second end faces are e.g. adjacent to the first and to the second skin, respectively.

Thereafter, a longitudinal plane is a plane parallel to the first and second end surfaces and a transverse plane is a plane orthogonal to the first and second end surfaces.

Similarly, a first longitudinal direction denoted X in a longitudinal plane, a second longitudinal direction denoted Y and perpendicular to the first longitudinal direction X in the same longitudinal plane and a transverse direction denoted Z which is orthogonal to the two longitudinal directions X and Y, are defined.

As can be seen in FIG. 1, the honeycomb structure 10 comprises a plurality of cells 12.

The cells 12 are adjacent to one another, forming a preferentially regular paving.

Each cell 12 extends between the first end face and the second end face.

Each cell 12 comprises a plurality of walls 14 delimiting the cell 12, each wall 14 extending transversely from the first end face to the second end face.

Each cell 12 is tubular and can have a polygonal section along a longitudinal plane.

Thereby, in the example proposed, each cell 12 is tubular with a polygonal section.

In the case of FIG. 1, the polygonal section is constant when the cell 12 is crossed along the transverse direction.

In the example illustrated, for simplicity, the longitudinal section of each cell 12 is a regular hexagon, but for the examples of the device, the longitudinal section is a non-regular hexagon.

The above implies that each cell 12 is delimited by six walls 14, certain walls 14 being common with other cells 12.

In a variant, the cross-section of a cell 12 has e.g. a square, rectangular, circular or elliptical geometry.

The walls 14 are formed from a dielectric material.

The dielectric material is e.g. an aramid sheet, or a cellulose paper or yet a thermoplastic material such as polyethylene, polypropylene, polyimide, polycarbonate or polyethylene terephthalate.

As can be seen in the enlarged view of FIG. 3, at least one cell 12 includes at least one strip 16 of electrically conductive coating arranged in at least one wall 14 or over a surface of at least one wall 14.

The electrically conductive coating strip 16 is e.g. made of a metallic material or a conductive organic material.

An organic material is a material comprising at least one bond selected from the group consisting of covalent bonds between a carbon atom and a hydrogen atom, covalent bonds between a carbon atom and a nitrogen atom, or bonds between a carbon atom and an oxygen atom. Polyaniline or poly(3,4-ethylenedioxythiophene): Poly(styrene sulphonate) (also denoted PEDOT/PSS) are two particular examples of conductive organic materials.

In particular, conductive inks with low resistivity charged with particles, are conceivable.

Examples of such particles are particles of micrometric size (each dimension less than 1 mm) and nanometric size (each dimension less than 1 μm).

Said particles are, e.g., silver, copper, gold, aluminum, carbon black, graphene, carbon nanotubes or a mixture thereof.

Otherwise formulated, the inner and/or outer faces of the cells 12 are made radioelectrically functional, in particular conducting, by depositing an electrically conductive coating.

Accordingly, the strip 16 can extend over all or part of the wall 14.

Such strips 16 can be produced by subtractive (chemical etching in particular) or additive manufacturing processes. Screen printing is preferred without being exclusive.

In each case, the production of the strip 16 remains easy, as demonstrated by the following description of an example of a method for manufacturing a honeycomb structure 10 using a screen printing technique.

The manufacturing method first comprises a step of printing strips 16 of electrically conductive coating.

The deposition by screen printing is done via a precise mask the image of which is engraved using a photosensitive capillary exposed on a canvas. The exposed canvas and frame assembly forms the screen for screen printing. The nature of the capillary and the canvas will be used for controlling the thickness of the deposits and the geometries thereof.

It should be noted that, for complex patterns, a plurality of masks can be used.

The deposition further includes a pulling operation during which a doctor blade placed under pressure on the cloth is moved in a horizontal translation. The ink is then transferred from the top of the screen to the support through the open pores of the screen.

A layer of adhesive is then deposited over a surface of at least one wafer of dielectric material.

It should be noted that the adhesive is, accordingly, added in the form of double-sided [adhesive], a transfer adhesive or a printed adhesive.

The nature of the adhesive is chosen according to the honeycomb structure 10 to be produced.

Then, the method includes a step of bonding the strips of dielectric material including the printed strips 16.

Alternatively, other methods such as ultrasonic welding are conceivable instead of using an adhesive layer.

The wafers are then assembled to form the plurality of tubular cells 12 with polygonal cross section.

More precisely, a stack of sheets is obtained.

The process further includes a step of expansion of the assembled wafers, so as to obtain a structure to be stiffened. Such expansion stage can take place in a controlled atmosphere.

In particular, the temperature, the humidity, the stretching force or the stretching speed can be controlled.

The structure to be stiffened is then cured during a curing step, so as to obtain the final honeycomb structure 10.

If appropriate, to improve certain properties of the honeycomb structure 10 (mechanical or thermal), dipping (especially in a resin bath), chemical deposition under vacuum or physical deposition under vacuum are used.

The above makes it possible to obtain a honeycomb structure 10 suitable for being integrated between two skins, so as to form a sandwich composite structure.

The behavior of such a structure from the electromagnetic point of view can be controlled by a suitable choice of the parameters of the honeycomb structure 10, parameters which are many as shown in the following examples.

A first example of a parameter for the honeycomb structure 10 is a geometry parameter of each cell 12.

According to FIG. 2, a plurality of parameters can be envisaged for the geometry of a cell 12.

E.g., the geometry can be characterized by the diameter D of the largest inscribable circle in the internal surface of the cell 12.

Another way of characterizing the geometry is to provide the dimension of a wall 14 along a longitudinal direction. Hereinafter, such dimension will be called “width”.

Yet another way is to provide angles such as the angle formed by a wall 14 and one of the longitudinal directions, e.g. the angle θ corresponding to the angle between the wall 14 and the longitudinal direction Y.

In the case of a non-regular hexagon, two successive angles can be provided between two sides, the first angle being called a and the second angle being called R. The angles are indicated in FIG. 2, as an indication only.

Alternatively or in addition, the thickness of a wall t or t′ (dimension in the direction perpendicular to the direction of the width) is another example of a parameter used for characterizing the geometry of a cell 12.

Similarly, the dimension along the transverse direction Z is another parameter independent of the other previous parameters. Hereinafter, such dimension will be called “height”.

A second example of a parameter is an electrical parameter of a band 16.

Typically, a conductivity value, an electrical resistivity value or yet a value of resistance per square of the strip 16 is a particular example of an electrical parameter.

Parameters similar to the parameters just mentioned for a wall 14 can be envisaged as a geometrical parameter of a strip 16.

The relative arrangement of the strips 16 with respect to the walls 14 is another parameter likely to influence the behavior of the honeycomb structure 10.

Indeed, as indicated above, the strip 16 is not necessarily printed over the entire height of the cell 12.

A fourth example of a parameter relates to the materials used, in particular for producing the walls 14.

Otherwise formulated, it is possible, through the determination of the parameters, to obtain the desired emission, transmission or electromagnetic absorption properties for the honeycomb structure 10.

To this end, it will suffice to implement an optimization method including first a step of choosing initial parameters for the honeycomb structure 10. Such selection step can be carried out by a random selection but preferentially, average parameters will be chosen with respect to the possible excursion of the different parameters.

The optimization process then includes an optimization step during which the parameters of the honeycomb structure 10 are optimized according to an optimization technique implemented by successive iterations on current sets of parameters, the first set of parameters being the set of initial parameters and the set of parameters of an iteration being the set of parameters obtained at the previous iteration, the optimization technique being implemented under the requirement that the honeycomb structure 10 or the device including the honeycomb structure 10 has the desired properties of electromagnetic emission, electromagnetic transmission or electromagnetic absorption.

Such method is a method implemented by a computer.

As a particular example, the above means that the interaction of a computer program product with a computer makes it possible to implement the optimization method.

More generally, the computer is an electronic computer suitable for manipulating and/or transforming data represented as electronic or physical quantities in computer registers and/or memories into other similar data corresponding to physical data in memories, registers or other types of display, of transmission or of storage.

The computer system includes a processor comprising a data processing unit, memories and a storage medium drive. The computer also comprises a keypad and a display unit.

The computer program product includes a readable storage medium.

A readable storage medium is a medium readable by the computer system, usually by the drive. The readable storage medium is a medium suitable for storing electronic instructions and apt to be coupled to a bus of a computer system.

As an example, the readable storage medium is a diskette or a floppy disk, an optical disk, a CD-ROM, a magneto-optical disk, a ROM, a RAM, an EPROM, an EEPROM, a magnetic card or an optical card.

A computer program containing program instructions is stored on the readable storage medium.

The computer program can be loaded into the data processing unit and is suitable for generating the implementation of the optimization method.

Thus, through the use of the optimization method, it is possible to control the electromagnetic properties of a honeycomb structure 10.

It is in this way possible to use same for a plurality of applications which are now presented successively.

Use of the Honeycomb Structure for Producing an Absorbent Structure

A first clever use of the honeycomb structure 10 which has just been presented is the use thereof for producing an absorbent structure 20 for electromagnetic waves and more specifically radio frequency waves.

The absorbent structure 20 is then formed by the honeycomb structure 10 then used for the absorption properties thereof.

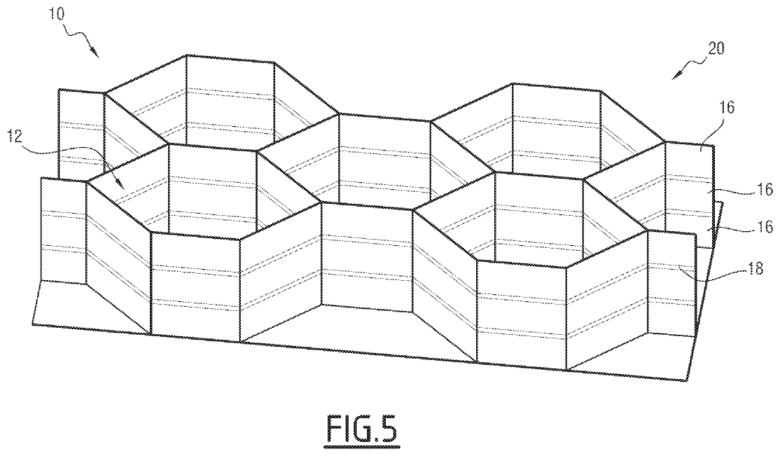

To show that it is possible to obtain an effective absorbent structure 20, a plurality of specific examples are now described with reference to FIGS. 5 to 11.

### Example 1

In the case of example 1, only one strip 16 of electrically conductive coating covers the entirety of the walls 14.

The coating strip 16 has a resistance per square of 900 Ohm per square (Ω/sq).

Furthermore, the height of each cell 12 is 11 millimeters (mm).

For the other parameters, the inter-cell space (distance between two cells 12 adjacent on the same line) is 10 mm, the angle α of one cell 12 is 70°, the angle β of one cell 12 is 145°, the length of an end face on which the honeycomb structure (10) rests is 72.54 mm and the width of said end face is 23.44 mm.

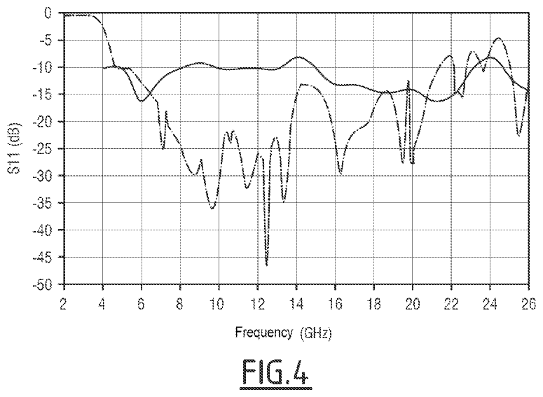

The performance of the absorbent structure 20 appear in FIG. 4 which is a graph showing the evolution of the attenuation of reflectivity provided by the absorbent structure 20 as a function of frequency.

The absorbent structure 20 has an attenuation of 10 dB over a wide frequency range (on the order of 16 GHz, mixed lines) with attenuation levels which are clearly higher than the levels known in the prior art (solid line).

### Example 2

The second example corresponds to the structure shown in FIG. 5.

In such an example, each cell 12 includes three distinct coating strips 16 having a distinct resistance per square, but the same thickness.

Moreover, the variation in the resistance per square of the strips 16 is strictly monotonic when the wall 14 of the cell 12 is crossed in the transverse direction.

In this sense, such an example corresponds to the deposition of electrically conductive gradient coatings.

According to the proposed example, the interval of resistance per square between two adjacent strips 16 is the same and equal to 100 Ω/sq.

More precisely, from the strip 16 furthest from the outer face on which the honeycomb structure 10 rests, the first strip 16 has a resistance per square of 300 Ω/sq, the second strip 16 has a resistance per square of 400 Ω/sq and the third strip 16 has a resistance per square of 500 Ω/sq.

Each strip 16 also has the same height of 3.3 mm.

It should also be noted that the space 18 between two adjacent strips 16 is identical and is equal to 500 micrometers (μm).

For the other parameters, the height of each cell 12 is 10.9 mm, the inter-cell space is 10 mm, the angle α of a cell 12 is 70°, the angle β of a cell 12 is 145°, the length of the end face is 72.54 mm and the width of the end face is 23.44 mm.

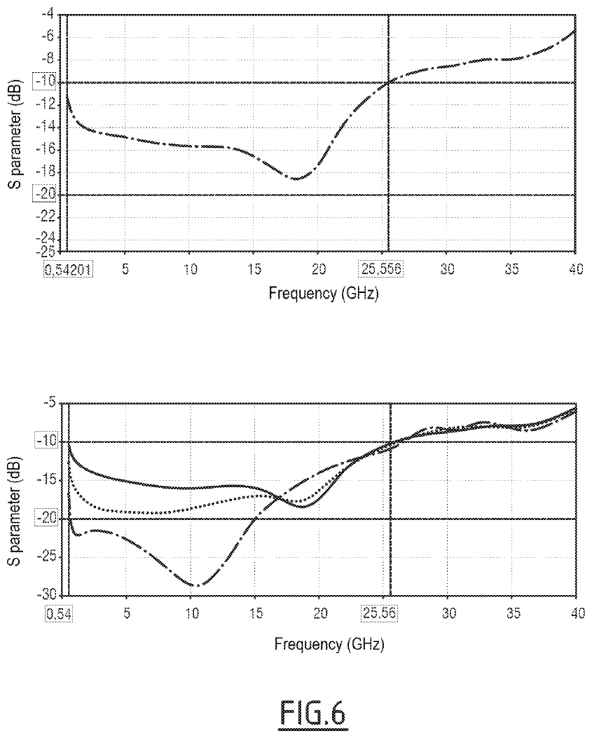

The two graphs of FIG. 6 show the evolution of the absorption of the structure according to example 2 in normal incidence (top graph) and in oblique incidence (bottom graph). In the case of oblique incidence, three curves are represented: a first curve in solid lines corresponding to the normal incidence (0°), a second curve in dashed lines corresponding to an incidence of ±20° and a third curve in dash-dotted lines corresponding to an incidence of ±40°.

It should be noted that, in all cases, the absorbent structure 20 has an attenuation of 10 dB over a very wide frequency range (on the order of 25 GHz) compared with the range of example 1. Such frequency band width is obtained by increasing the attenuation of the absorbent structure 20 at low frequencies related to the presence of the gradient of resistance per square.

Moreover, the performance of the absorbent structure 20 improves with the incidence and the decrease in frequency.

### Example 3

The absorbent structure 20 according to the third example has the same features as the structure of the second example which are not repeated, so that only the differences with the absorbent structure 20 of the second example are now described.

A fourth additional strip 16 is added in addition to the three strips 16. The fourth strip 16 has a resistance per square of 200 Ω/sq and is placed above the first strip 16.

Moreover, the heights of the strips 16 and the height of the cell 12 are different compared with the second example.

More precisely, the height of the first, second and fourth strips 16 is 4.9 mm and the height of the third strip 16 is 3.9 mm.

As a result, the height of the cell 12 is 20.1 mm. The length of the end face is 72.54 mm and the width of the end face is 23.34 mm.

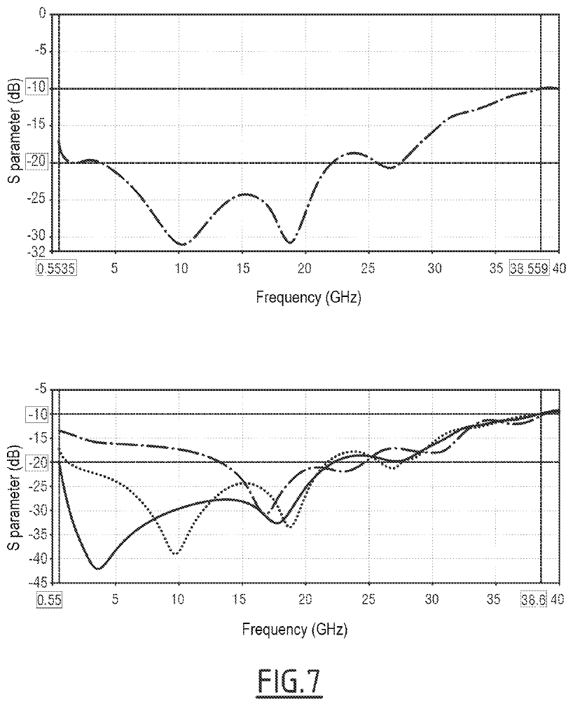

The two graphs of FIG. 7 show the evolution of the absorption of the structure according to example 3 in normal incidence (top graph) and in oblique incidence (bottom graph).

The analysis of the graphs of the FIG. 7 shows that the performance level of the absorbent structure 20 is very significantly increased compared to the level of the honeycomb structures of the first example and of the second example since, under normal incidence, an attenuation level of 20 dB over a frequency range of 3.9 GHz to 22.24 GHz is obtained. More precisely, a gain of 10 dB in the optimum level is obtained with respect to the absorbent structure 20 of the first example and of the second example.

A significant widening of the attenuation frequency band from 10 dB up to very high frequencies (up to 38 GHz) is observed under normal (dotted lines) and oblique (±20° (solid line); ±40° (mixed lines) incidences). The attenuation level of 20 dB is also very satisfactory at an incidence of ±20° with respect to the normal.

### Example 4

The absorbent structure 20 according to the fourth example has the same features as the structure of the third example which are not repeated, so that only the differences with the absorbent structure 20 of the third example are now described.

The heights of the strips 16 and the height of the cell 12 are different compared to the third example.

More precisely, the height of the strips 16 is the same for all and is equal to 2.4 mm.

As a result, the height of the cell 12 is 11.1 mm.

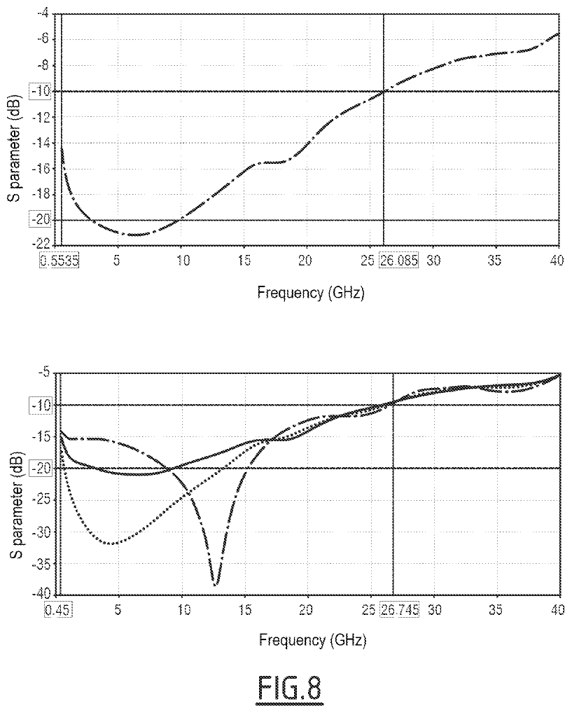

The two graphs of FIG. 8 show the evolution of the absorption of the structure according to example 4 in normal incidence (top graph) and in oblique incidence (bottom graph).

The analysis of the graphs in said figure shows that at oblique incidence at ±20° (dotted lines), the performance level of the absorbent structure 20 of the fourth example is improved compared to the level of the absorbent structure 20 of the second example, mainly at low frequencies (in particular, frequencies below 15 GHz).

### Example 5

The absorbent structure 20 according to the fifth example has the same features as the structure of the first example which are not repeated, so that only the differences with the absorbent structure 20 of the first example are now described.

In the first four examples, the strip 16 is continuous over the entire height of the wall 14 of the cell 12.

On the other hand, in the two examples which follow, the width of the strip 16 varies along the longitudinal directions.

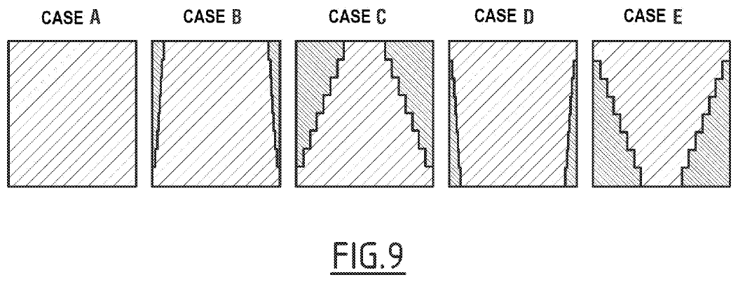

FIG. 9 shows a set of patterns corresponding to a variation of possible widths for the strip 16 at constant height.

There are five patterns and are referred to as cases A, B, C, D and E, respectively.

In each case, the variation is a variation in stair-steps according to 7 levels and in a constant manner.

It can therefore be considered that the variation corresponds to a variation in the form of a pyramid, denoting by “a” the width at the top of the pyramid and by “b” the width at the bottom of the pyramid, each of the cases A, B and C being characterized by different values of width at the top “a”, the width at the foot “b” being set at 8 mm.

More precisely, for case A, the width at the apex is 7.86 mm (which corresponds to an a/b ratio of 0.98); for case B, the width at the apex is 6.81 mm (which corresponds to an a/b ratio of 0.85) and for case C, the width at the apex is 2.33 mm (which corresponds to an a/b ratio of 0.29).

Cases D and E correspond to the inverse of cases B and C.

For the fifth example, the width of the strip 16 varies according to the pattern of case B with a resistance per square of the conductive coating equal to 400 Ω/sq.

In addition, the height of a cell 12 is 8.0 mm and the inter-cell space 12 is 8.0 mm. The length of the end face is 174.15 mm and the width of the end face is 55.38 mm.

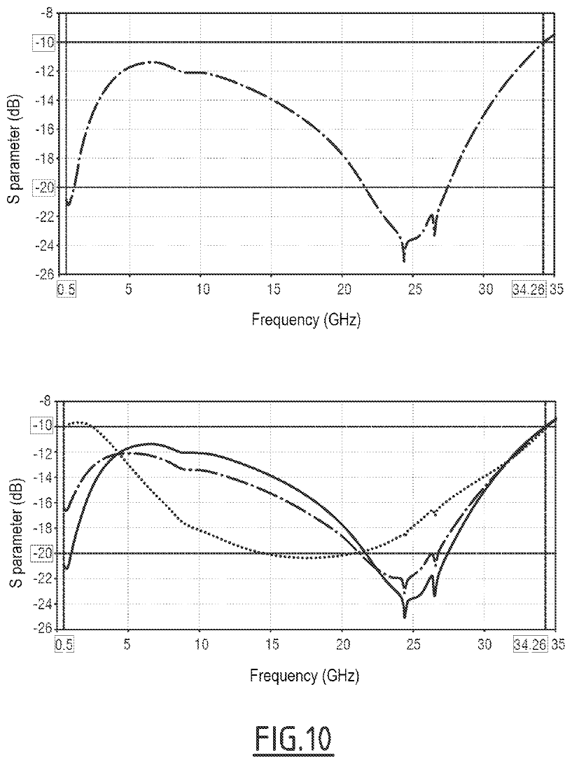

The two graphs of FIG. 10 show the evolution of the absorption of the structure according to example 5 in normal incidence (top graph) and in oblique incidence (bottom graph).

The study of the graphs of FIG. 10 shows that the fifth example is particularly suitable for incidences of ±40° (dotted lines) where interesting absorption performance is obtained, at the price of degradation of the absorption level for the lower incidences (0° (solid line) and ±20° (dash-dotted lines).

### Example 6

The absorbent structure 20 according to the sixth example has the same features as the structure of the third example which are not repeated, so that only the differences with the absorbent structure 20 of the third example are now described.

The heights of the strips 16 and the height of the cell 12 are different compared to the third example.

More precisely, the height of the strips 16 is the same for all and is equal to 4.4 mm.

As a result, the height of the cell 12 is 17.6 mm.

In addition, the width of the strip 16 varies according to the strip 16 considered, the fourth strip 16 having a width of 10 mm, the first strip 16 a width of 7.4 mm, the second strip 16 has a width of 8.4 mm and the third strip 16 has a width of 9.4 mm.

From the strip 16 furthest from the outer face on which the honeycomb structure 10 rests, the fourth strip 16 has a resistance per square of 500 Ω/sq, the first strip 16 has a resistance per square of 260 Ω/sq, the second strip 16 has a resistance per square of 340 Ω/sq and the third strip 16 has a resistance per square of 420 Ω/sq.

Concerning the other parameters, the inter-cell space is 10 mm, the angle α of a cell 12 is 70°, the angle β of a cell 12 is 145°, the length of the end face is 72.5 mm and the width of the end face is 23.3 mm.

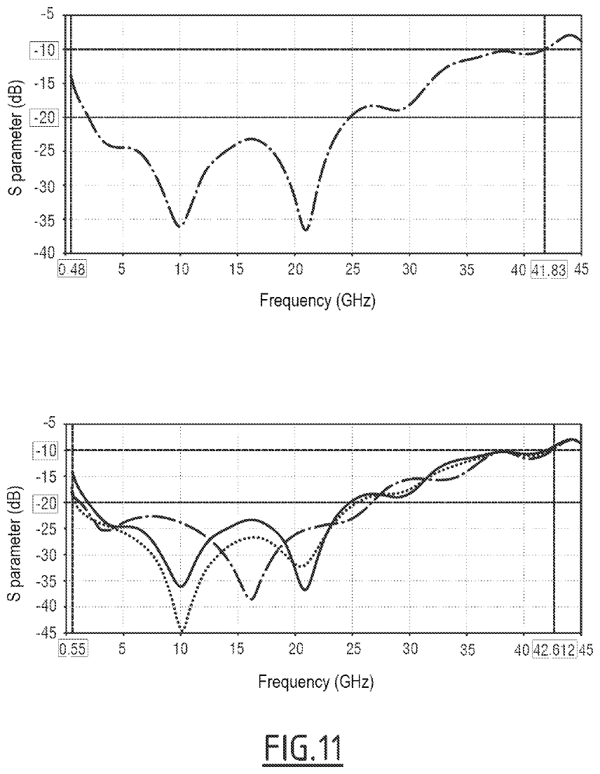

The two graphs of FIG. 11 show the evolution of the absorption of the structure according to example 6 in normal incidence (top graph) and in oblique incidence (bottom graph).

Analysis of the graphs in said figure shows that both in normal incidence (solid line, bottom graph) and oblique incidence (±20° (dotted lines) and ±40° (dash-dotted lines), an attenuation of 20 dB is obtained for a frequency range with a spread of 23 GHz (2 GHz to 25 GHz).

The above means that the sixth example corresponds to an example of an optimized 20 absorbent structure, the optimization taking into account the fact that the following observations were made by comparison with the previous examples:
the controlled gradient of resistance per square contributes to significantly improving the absorption performance at low frequencies,
the increase in the height of the strips 16 makes it possible to substantially increase the absorption level from 5 to 10 dB in relation to low incidences,
the increase in the height of the 16 strips extends the frequency range within which attenuation of a level of 10 dB is obtained for normal incidence up to frequencies on the order of 40 GHz, and
the introduction of a pattern for the variation of the width of the strips 16 improves the performance at high incidence (±20°; ±40°) up to frequencies on the order of 40 GHz.

Such honeycomb structures are used for obtaining a good absorption performance (more than 20 dB) at different angles (up to ±40°).

Furthermore, such good absorption performance is maintained over a wide frequency range of at least 20 GHz.

To be complete, it may be noted that such performance will be preserved in the complete composite sandwich structure by selecting materials which are either absorbent or transparent to electromagnetic waves for each of the skins.

It thereby appears that it is possible to obtain the desired absorption for the honeycomb structure 10.

The above means that the use of the basic structure offers the freedom to obtain the desired absorption for the absorbent structure 20 by adapting the parameters of each honeycomb assembly.

More precisely, the parameters of the honeycomb structure 10 are chosen so that the absorbent structure 20 provides an attenuation of at least 10 dB for each incident wave in a frequency range having a frequency spread greater than or equal to 15 GHz.

Preferentially, accordingly, the frequency range is greater than or equal to 20 GHz, and even better if possible, greater than or equal to 25 GHz.

In addition or alternatively, the attenuation is at least 15 dB, or even 20 dB.

Moreover, in some examples, the frequency range over which attenuation occurs begins at 10 MHz.

Furthermore, the honeycomb structures contribute to the mechanical strength of sandwich composite structures.

The weight associated with the honeycomb structures is also low.

The above ensures lasting absorption performance of the honeycomb structures.

Thereby, the proposed absorbent structure 20 can be used for obtaining very high and lasting attenuation performance in terms of attenuation level, frequency range and stability in oblique incidences.

Moreover, since the honeycomb structure 10 is hollowed out at core, a lighter weight is obtained compared with other absorbent structures of the prior art.

Such lighter weight can be obtained without significantly making the manufacture of the absorbent structure 20 more complex.

The method for manufacturing a honeycomb structure 10 described above is indeed applicable herein for producing the absorbent structure 20.

Furthermore, the absorbent structure 20 can easily be integrated into a wall 14.

Such an absorbent structure 20 is advantageous for many applications involving electromagnetic discretion and/or problems of electromagnetic compatibility between radio frequency systems.

Use of the Honeycomb Structure for Making a Radio Frequency Lens

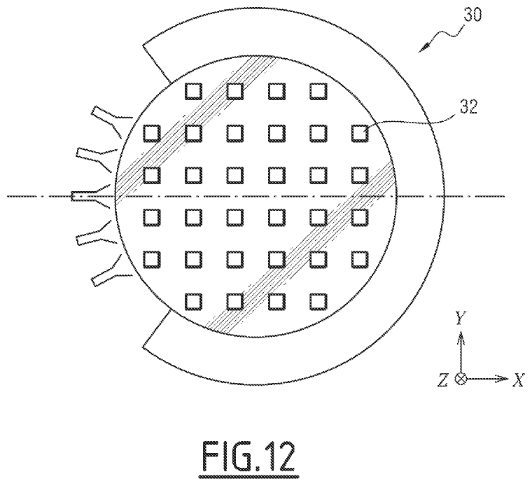

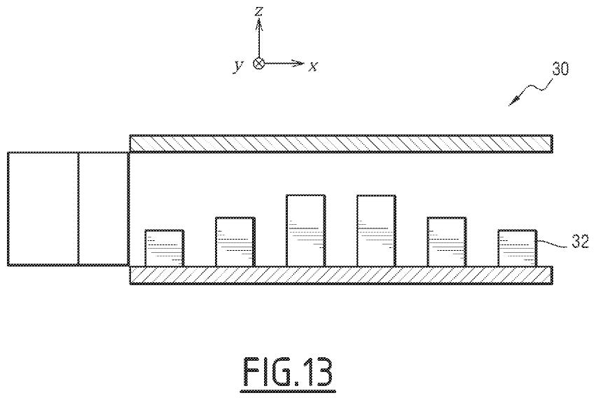

A radio frequency lens 30 using the same basic honeycomb structure 10 is now described with reference to FIGS. 12 to 14.

A radio frequency lens 30 is a device suitable for converging or diverging incident electromagnetic wave beams.

In the case of convergence, the term “focusing lens” or “focusing device” can be used.

The radio frequency lens 30 includes a plurality of conductive studs 32.

A stud 32 can be seen as an obstacle generally with a cylindrical shape in the broad sense (including any basic shape for the cylinder).

The dimensions of the studs 32 and the mutual distances thereof are usually small compared to the strip at which the radio frequency lens 30 operates.

The distance between the studs 32 and the height thereof form an equivalent medium with variable index. As a result, the studs 32 are used for reproducing the same propagation effect as in a conventional dielectric medium in which the refractive index varies from 2 to the limit lower than unity, starting from the peripheral to the center of the radio frequency lens 30.

A stud 32 is thus a part of the radio frequency lens 30 which includes a plurality of lenses, so as to obtain such an effect.

In addition, the material of the studs 32 is different from the material forming the medium surrounding the studs 32.

Each stud 32 is a honeycomb assembly having said honeycomb structure 10.

Thereby, each cell assembly comprises at least one tubular cell 12 with polygonal cross-section in a plane parallel to at least one of the end faces, called the first plane, each cell 12 including a plurality of walls 14 delimiting said cell 12, the walls 14 extending from a first end face to a second end face, the walls 14 being formed from a dielectric material, at least one cell 12 including at least one strip 16 of electrically conductive coating arranged on at least one wall 14.

As explained hereinabove, each honeycomb assembly has parameters. As an example, the parameters of each honeycomb assembly are the geometrical and dielectric parameters of each honeycomb 12 and the electrical, dielectric and geometrical parameters of each strip 16.

A center O is defined for the radio frequency lens 30.

According to the example proposed, the studs 32 are distributed in a plurality of zones Z1, Z2, Z3, Z4, Z5, Z6, the parameters of the honeycomb assemblies of the same zone Z1, Z2, Z3, Z4, Z5, Z6 being identical.

In the present case, each stud 32 of the same zone Z1, Z2, Z3, Z4, Z5, Z6 has the same height.

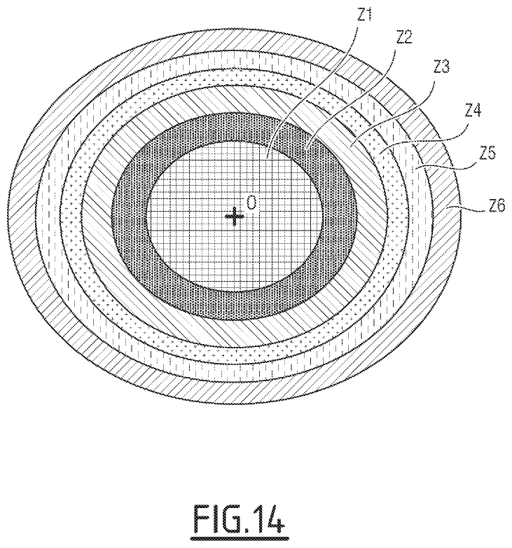

As can be seen in FIG. 14, the zones Z1, Z2, Z3, Z4, Z5, Z6 are concentric, the center of the zones Z1, Z2, Z3, Z4, Z5, Z6 is the center O of the radio frequency lens 30.

The first zone Z1 is a disk and the other zones Z2, Z3, Z4, Z5, Z6 are rings surrounding the preceding zone.

In the example described, the lens includes five annular zones Z2, Z3, Z4, Z5, Z6 so that the total number of zones Z1, Z2, Z3, Z4, Z5, Z6 is 6.

It results therefrom also that the surface of the radio frequency lens 30 is a disk having a radius R.

In the example described, the radius is equal to 250 mm.

Each zone Z1, Z2, Z3, Z4, Z5, Z6 can be identified by the geographical position thereof with respect to the center of the radio frequency lens 30.

More precisely, a stud 32 of the first zone Z1 is situated at a distance x comprised between 0 and 0.4×R from the center of the radio frequency lens 30; a stud 32 of the second area Z2 is situated at a distance x between 0.4×R and 0.54×R from the center of the radio frequency lens 30; a stud 32 of the third area Z3 is situated at a distance x between 0.54×R and 0.68×R from the center of the radio frequency lens 30; a stud 32 of the fourth area Z4 is situated at a distance x between 0.68×R and 0.78×R from the center of the radio frequency lens 30; a stud 32 of the fifth area Z5 is situated at a distance x between 0.78×R and 0.88×R from the center of the radio frequency lens 30 and a stud 32 of the sixth zone Z6 is situated at a distance x comprised between 0.88×R and 1.0×R from the center of the radio frequency lens 30.

As indicated above, the height of the studs 32 varies from one zone Z1, Z2, Z3, Z4, Z5, Z6 to the other. More specifically, in the first zone Z1, the studs 32 have a height of 4.86 mm; a height of 4.57 mm in the second zone Z2; a height of 4.24 mm in the third zone Z3; a height of 3.85 mm in the fourth zone Z4; a height of 3.25 mm in the fifth zone Z5 and a height of 1 mm in the sixth zone Z6.

Furthermore, as can be seen in FIG. 12, the studs 32 are evenly distributed over the surface of the radio frequency lens 30.

Such a configuration of the studs 32 is used for obtaining an equivalent medium with a variable refractive index, i.e. for obtaining a spatial variation of effective refractive index.

In such a case, preferentially, the medium surrounding the studs 32 is not produced by using a honeycomb assembly.

Thus, in the first zone Z1, the effective refractive index is 1.4; in the second zone Z2, the effective refractive index is 1.33; in the third zone Z3, the effective refractive index is 1.27; in the fourth zone Z4, the effective refractive index is 1.2; in the fifth zone Z5, the effective refractive index is 1.14 and in the sixth zone Z6, the effective refractive index is 1.02.

The above enables the radio frequency lens 30 to produce an effective index gradient corresponding to a spatial variation of the refractive index from 1.4 to 1, the variation according to the mathematical law \sqrt{2−x²} where x is representative of the position of the zone Z1, Z2, Z3, Z4, Z5, Z6 considered.

At least one source is integrated into the honeycomb at the focal point of the lens (see FIG. 12).

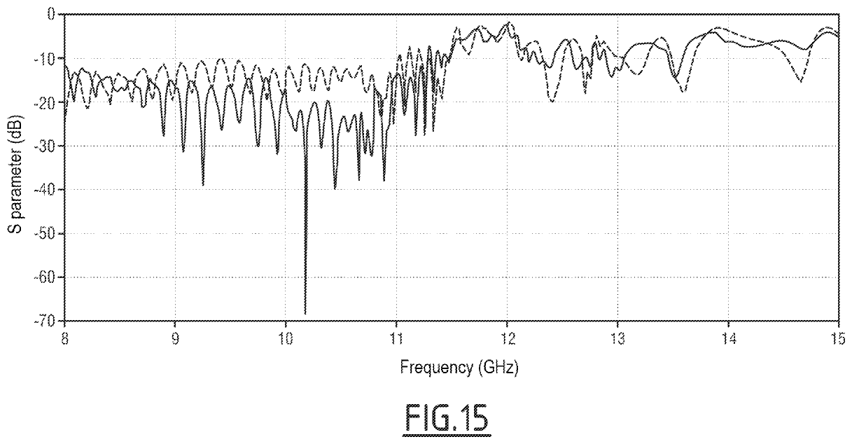

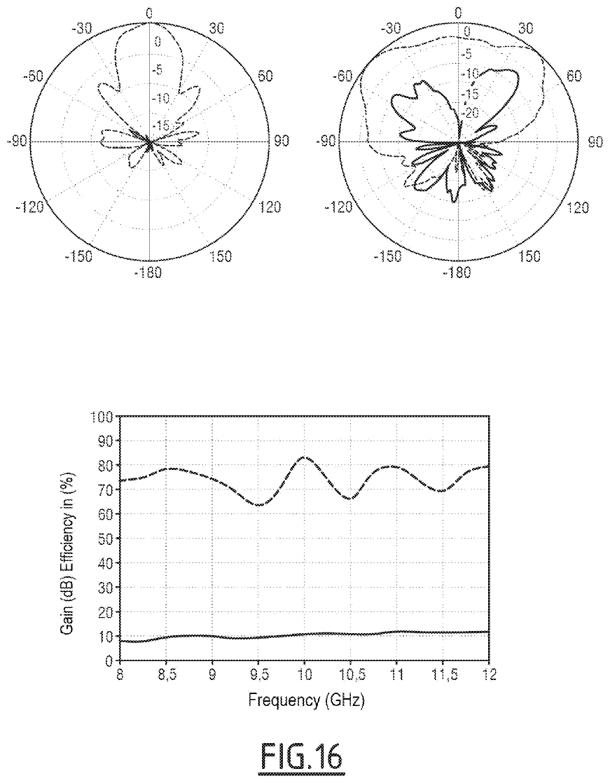

The performance obtained by such a radio frequency lens 30 is shown in FIGS. 15 and 16.

FIG. 15 shows the evolution of the lens adaptation according to the frequency when the source is at the focal point of the lens (curve in solid lines) and for a displacement of the source of a few millimeters with respect to the focal point of the lens (dotted line curve).

The figure shows that the radio frequency lens 30 works correctly between 8 GHz and 12 GHz even if the source is slightly offset.

In contrast to FIG. 15 obtained by electromagnetic simulation, FIG. 16 was obtained with a prototype for which the radius of the radio frequency lens 30 was 50 mm instead of 250 mm for the simulation shown in FIG. 15.

FIG. 16 includes three graphs.

The graph at the top left is a radiation pattern representing the evolution of the amplitude of the electromagnetic field in the plane H as a function of the azimuth angle. The frequency is set at 9.4 GHz.

The graph at the top right is a radiation pattern representing the evolution of the amplitude of the electromagnetic field in the plane E as a function of the angle of elevation. The frequency is set at 9.4 GHz.

The bottom graph represents the evolution of the gain as a function of the frequency (solid line curve) as well as the evolution of the efficiency as a function of the frequency (dotted line curve).

By definition, gain is the ratio between the power density radiated in one direction and the power density that would be radiated by an isotropic radiation antenna in the same direction. An isotropic antenna is an ideal antenna consisting of a point source which radiates the same power in all directions of space (gain equal to 1).

Directivity D represents the ratio between the radiated power in a given direction and the average radiated power of the antenna. The difference between directivity and gain takes into account antenna losses. In the case of a lossless antenna, the directivity will thus be equal to the gain. The relationship between the gain G and the directivity D is then written as a function of the efficiency η of the antenna, according to G=ηD.

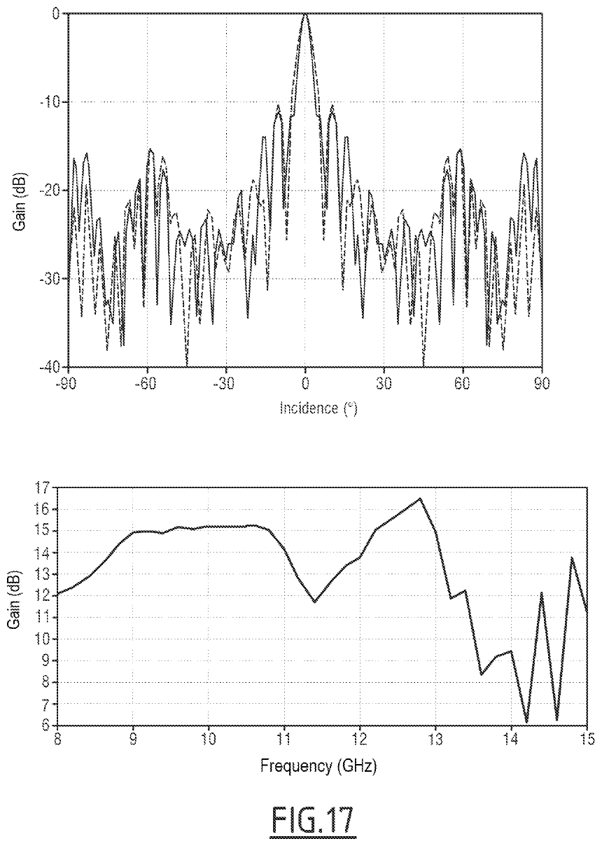

FIG. 17 shows other results obtained by simulation, for a lens with a radius of 250 mm.

FIG. 17 shows, at the top, a graph showing the variation of the gain in the plane H at 9.4 GHz after passing through the lens, as a function of the azimuth angle. The shift of the source by a few millimeters (dashed line curve) with respect to the focal point of the lens (solid line curve) has no influence on the focusing of the gain. The bottom graph shows the variation of the far field gain after passing through the lens, but this time as a function of frequency.

The study of FIGS. 16 and 17 shows that the performances of the radio frequency lens 30 are satisfactory.

Such a lens thus performs the desired function.

The above means that the use of the basic structure offers the freedom to obtain a desired function by adapting the parameters of each honeycomb assembly.

Preferentially, as is the case in the example described, the parameters of each honeycomb assembly are chosen so that the lens exhibits a predefined spatial variation of effective refractive index, in particular a gradient from the center of the lens.

As a variant or in addition, the parameters of each honeycomb assembly are chosen so that the lens has a gain greater than 5 dBi over a range from 8 GHz to 12 GHz.

Compared with a metal stud, the conductive stud 32 formed by a honeycomb assembly is hollowed out at core, which results in a lighter weight.

Such lighter weight can be obtained without significantly making the manufacture of the radio frequency lens 30 more complex.

The method for manufacturing a honeycomb structure 10 described hereinabove is applicable for each of the studs 32.

Furthermore, the radio frequency lens 30 can easily be integrated into a wall element made of composite materials.

Such integration can also be improved by printing the excitation sources of the radio frequency lens 30. It is thus possible, in particular, to simplify the mechanics associated with the radio frequency feed thereof.

Such a radio frequency lens 30 is in particular advantageous in the field of telecommunications and of detection.

Use of the Honeycomb Structure for Making a Part of an Antenna System

In the previous part, it was presented how to adapt the parameters of the basic structure to achieve a focusing function.

How to produce other radio frequency functions is now presented.

For this purpose, a plurality of antenna systems is described, each antenna system 40 including at least one part which is a honeycomb structure 10 as previously proposed.

In each case, the plurality of walls 14 is optically transparent.

The above means that each wall 14 has an optical transmittance greater than 80% at least one wavelength belonging to the visible range.

The optical transmittance is defined by the ratio of the light intensities before and after crossing the wall 14 and the visible range is defined as combining all wavelengths comprised between 400 nanometers (nm) and 800 nm.

As an example, the walls 14 are made of a polymer based on polyethylene terephthalate (PET) having such optical transparency properties.

### Example 1

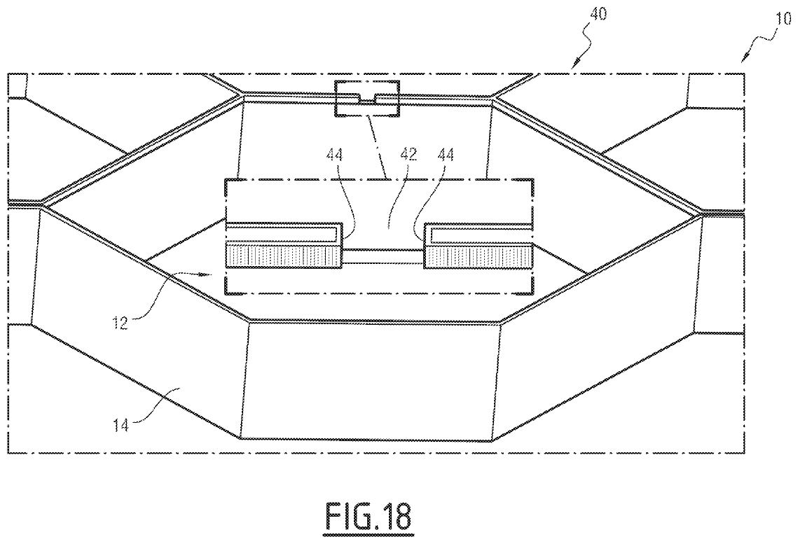

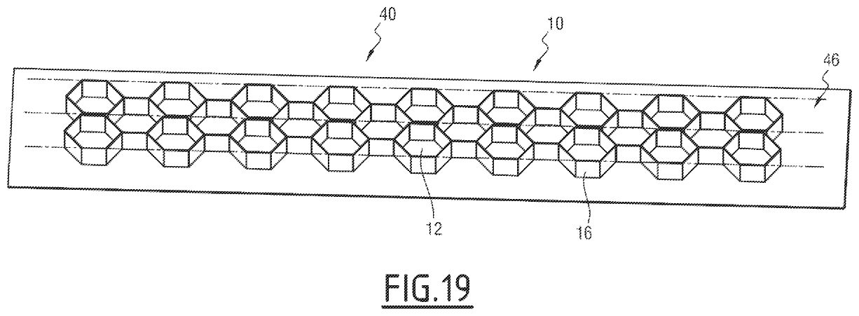

A first example of an antenna system 40 is presented with reference to FIGS. 18 and 19.

An optically transparent grid antenna array with directional radiation is concerned.

Each cell 12 is then a radiating structure due to the addition of at least one strip 16 of electrically conductive coating.

FIG. 18 illustrates a pattern which is particularly suitable for such case. It concerns a wall 14 having a central recess 42, a conductive strip 16 surrounding the wall 14 so that in the central recess 42, two portions 44 of conductive strip 16 face each other.

Furthermore, a honeycomb structure 10 having only three lines 46 of cells 12 as can be seen in FIG. 19 is particularly suitable.

In such a case, the control law applied to the antenna system 40 is a feed in phase of each radiating structure.

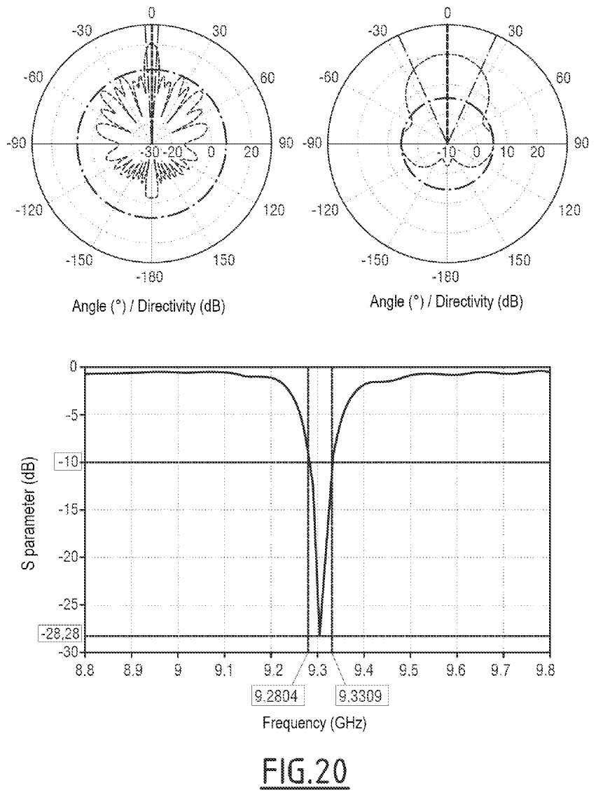

The performance of the first example of antenna system 40 is shown in FIG. 20.

FIG. 20 includes three graphs.

The graph at the top left of FIG. 20 is a radiation pattern representing the evolution of the amplitude of the electromagnetic field in the plane E (plane orthogonal to the surface of the antenna and comprising the main length thereof) as a function of the angle of elevation thereof. The working frequency is set at 9.3 GHz.

The graph at the top right of FIG. 20 is a radiation pattern representing the evolution of the amplitude of the electromagnetic field in the plane H (plane orthogonal to the surface of the antenna and including the main width thereof) as a function of the angle of elevation. The frequency is set at 9.3 GHz.

The bottom graph of FIG. 20 shows the adaptation of the antenna system 40 according to the frequency. The adaptation thereof is optimal at 9.3 GHz.

The different figures show that the antenna is directional in the plane E.

### Example 2

The second example corresponds to a sector radiation grid antenna array.

Such an array is physically identical to the array shown in FIGS. 18 and 19.

Only the way to control same differs, a cardinal sine amplitude and phase law being imposed.

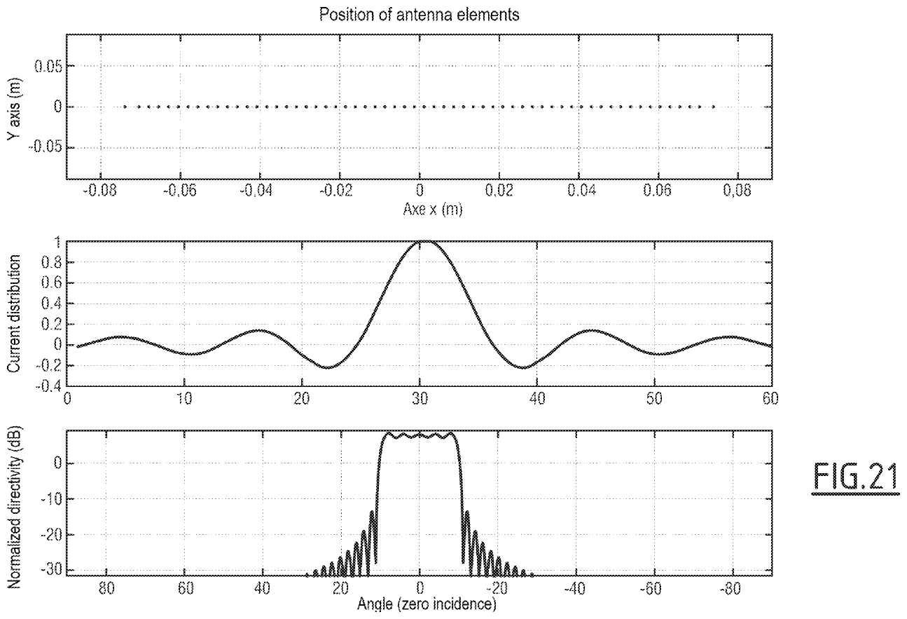

The performance of the second example of an antenna system 40 is shown in FIGS. 21 to 23 and FIG. 24.

FIG. 21 includes three graphs.

The graph at the top of FIG. 21 is a diagram showing schematically the position of the antenna elements within the honeycomb along the longitudinal direction, the graph in the middle gives the current distribution applied to the antenna elements, and the graph at the bottom gives the directivity (normalized) resulting from such a feed.

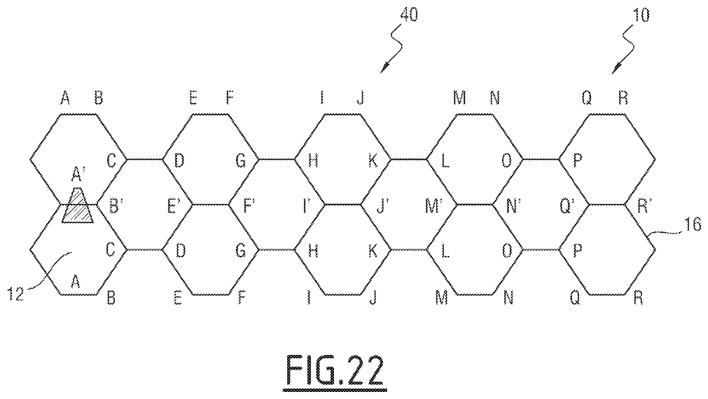

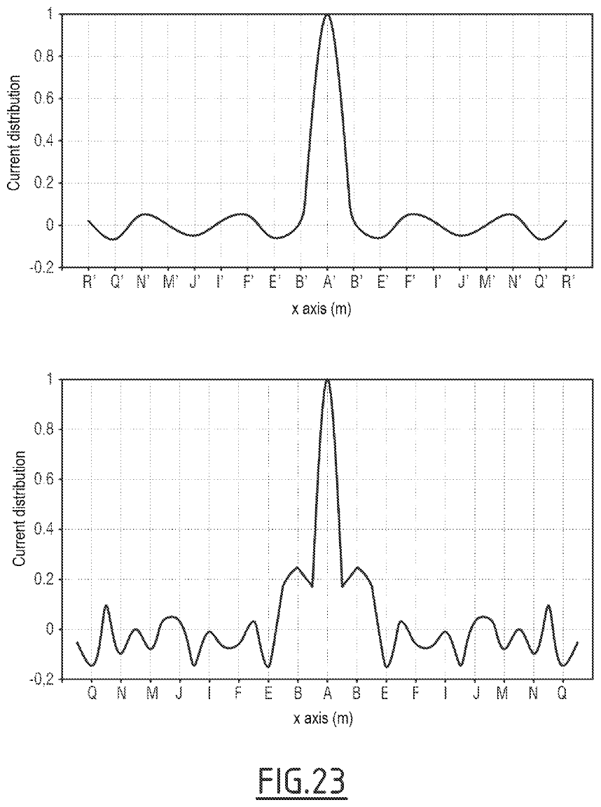

The directivity is satisfactory because, as shown in FIGS. 22 and 23, a cardinal sine control law both in phase and in amplitude feeds the different antenna elements.

More precisely, FIG. 23 shows the current distribution along the cells 12 of the central line identified in FIG. 22 from notation A′ to notation R′ (top graph in the FIG. 23) and for a line situated at the end identified in FIG. 22 by the notation A to the notation R (bottom graph in the FIG. 23).

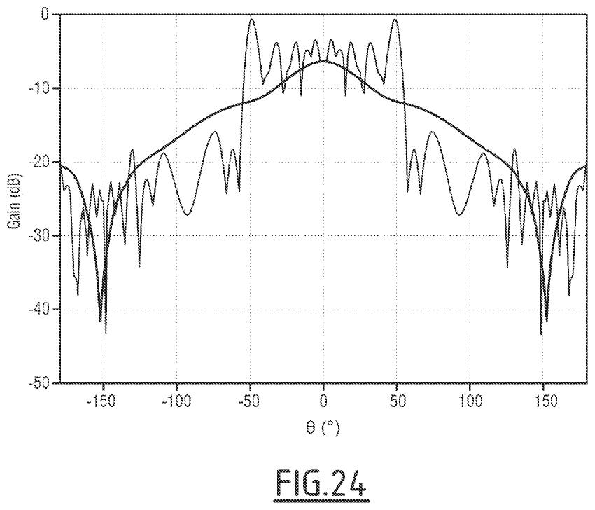

FIG. 24 shows the evolution of the gain as a function of the angle of elevation. The evolution of the gain is presented for two planes: Plane E (thick line curve in FIG. 24) and plane H (thin line curve in FIG. 24). In said example, the working frequency is set at 9.3 GHz.

The FIG. 24 shows the advantage of using the honeycomb structure 10 in such case. Indeed, the gain is thus obtained from a sector antenna without using any additional equipment such as phase shifters or attenuators for applying the control, which simplifies the set-up.

### Example 3

The third example corresponds to a patch or slot grid antenna.

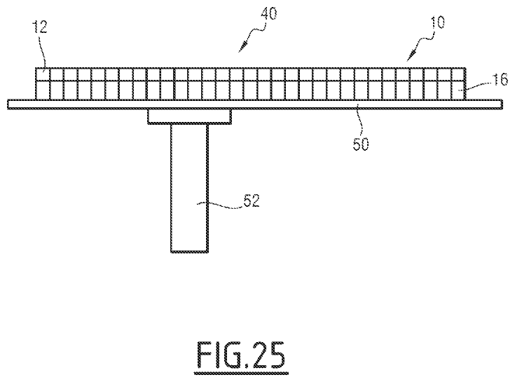

The antenna 40 according to the second example is shown schematically in FIG. 25.

In the FIG. 25, the antenna system 40 comprises the honeycomb structure 10 positioned on a reflector plane 50, said plane being in contact with a coaxial probe 52 which feeds the patch grid antenna.

According to the example described, the reflector plane 50 is the carbon skin of the composite sandwich structure associated with the antenna system 40.

In a variant, the reflector plane 50 is made similar to the radiating element positioned in the upper part of the honeycomb structure 10 except that the conductive coating strips are arranged at the base of each of the constituent cells of the honeycomb structure 10 and form an array of conductive rings hence ensuring a reflection function.

Of course, it is possible to envisage such a reflector plane 50 for other applications, in particular for a reflector plane antenna such as a parabolic antenna or else as an electromagnetic shielding element between radio frequency systems.

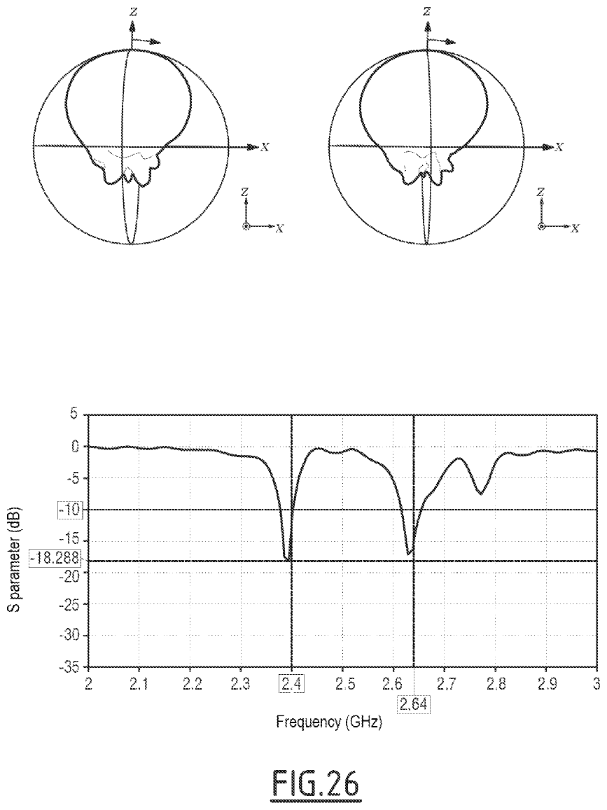

The performance of the first example of antenna system 40 is shown in FIG. 26.

FIG. 26 includes three graphs.

The graph at the top left of FIG. 26 is a radiation pattern representing the evolution of the amplitude of the electromagnetic field in the E plane as a function of the angle of elevation. The frequency is set at 2.4 GHz.

The graph at the top right of FIG. 26 is a radiation pattern representing the evolution of the amplitude of the electromagnetic field in the plane H, as a function of the angle of elevation. The frequency is set at 2.6 GHz.

The graph at the bottom of FIG. 26 represents the evolution of the adaptation of the antenna system 40 as a function of the frequency.

The analysis of FIG. 26 shows that the antenna system 40 is perfectly suitable (reflection coefficient S₁₁ less than −15 dB) for two operating frequencies (2.4 GHz and 2.62 GHz) leading to gains greater than 5 dBi obtained at the two frequencies (6.1 dBi and 8.4 dBi, respectively).

The analysis of the three examples presented shows that the use of the basic structure offers the freedom to obtain a desired function for the antenna system 40 by an adaptation of the parameters of each honeycomb assembly.

More precisely, the parameters of each cell 12 are chosen so that the antenna system 40 has an optical transmittance of at least 80% for an electromagnetic wave belonging to the visible range and having an incidence substantially normal to the foreground.

Preferentially, as is the case in some of the examples described, the parameters are chosen so that the antenna system 40 presents a desired radiation pattern.

As an example, in the case of the second example, the radiation pattern is such that each cell 12 in combination with the other cells 12 of the plurality of cells has a sector radiation (see FIG. 24) due to the feed of the antenna elements according to a cardinal sine law.

In certain cases, the antenna system 40 advantageously comprises a supplementary strip 16 of electrically conductive coating arranged in at least one wall 14, the supplementary strip 16 being arranged between the at least one coating strip 16 and an end face so as to form a ground plane and/or a reflector plane for the antenna system 40.

Accordingly, it should be noted that the height of the strip 16 varies between 10 micrometers and the height of the cell 12 including the wall 14 wherein or on which the strip 16 is arranged, said height of the strip 16 preferentially varying between 10 micrometers and 500 micrometers.

Finally, such a technology is compatible with any type of antenna, and in particular a wire antenna, a patch antenna or an antenna requiring a reflector plane.

Compared to other antenna systems, the antenna system 40 formed of a honeycomb assembly is hollowed out at core, which results in a lighter weight.

Such lighter weight can be obtained without significantly making the manufacture of the antenna system 40 more complex.

The method for manufacturing a honeycomb structure 10 can indeed be used directly.

Furthermore, the antenna system 40 can easily be integrated into a wall element made of composite materials.

The different properties which have just been described make the different antenna systems suitable for different applications.

As an example, such antenna systems can be used in the field of transport, in particular air, rail or naval transport. In such applications, the better integration of antenna systems leads to obtaining a significant gain in aerodynamics.

Uses could also be envisaged in fields such as aerospace, urban furniture, telecommunications, building industry, the service industries or the Internet of things.

It should be noted that, as previously, in order to guarantee good performance, it will be necessary to choose skins suitable for forming the associated sandwich composite structure.

The interest of a honeycomb structure 10 been shown through three particular examples of devices as described in FIGS. 1 to 3.

In each case, the devices obtained lead to a better integration in a carrier while remaining easy to manufacture and while presenting, for some, performance unmatched by the other known solutions. Such is particularly the case for the absorbent structure 20.

1. An absorbent structure, the absorbent structure being a honeycomb structure extending between a first end face and a second end face, the honeycomb structure comprising a plurality of tubular cells, each cell having a plurality of walls defining said cell, the walls extending from the first end face to the second end face, the walls being formed from a dielectric material, at least one honeycomb with at least one strip of electrically conductive coating arranged in at least one wall or over a surface of at least one wall, the honeycomb structure being characterized by parameters, the parameters of the honeycomb structure being chosen so that the absorbent structure provides an attenuation of at least 10 dB for each incident wave in a frequency range having a frequency spread greater than or equal to 15 GHz.

2. The absorbent structure according to claim 1, wherein the parameters are the dielectric and geometric parameters of each cell and the electrical and geometric parameters of each strip.

3. The absorbent structure according to claim 1, wherein the at least one cell includes two distinct coating strips having a distinct resistance per square.

4. The absorbent structure according to claim 3, wherein when the wall of the cell is crossed along in a direction perpendicular to the plane parallel to at least one of the two end faces, the variation in the resistance per square of the strips is strictly monotonic.

5. The absorbent structure according to claim 3, wherein when the wall of the cell is crossed along in a direction perpendicular to the plane parallel to at least one of the two end faces, the resistance per square of two adjacent strips differs from an interval of resistance per square comprised between 10 Ohms/sq and 500 Ohms/sq.

6. The absorbent structure according to claim 1, wherein at least one strip has a height, said height varying along a direction perpendicular to a plane parallel to at least one of the two end faces.

7. The absorbent structure according to claim 6, wherein the width of the strip varies according to a stair-step variation or according to a strictly monotonic variation along a direction perpendicular to the plane.

8. The absorbent structure according to claim 3, wherein the space between two adjacent strips is comprised between 100 micrometers and 1000 micrometers.

9. The absorbent structure according to claim 1, wherein the height of the wall along a direction perpendicular to the plane is comprised between 5 millimeters and 50 millimeters.

10. A composite sandwich structure comprising a core interposed between a first skin and a second skin, said core comprising at least one absorbent structure according to claim 1.

11. A method of manufacturing an absorbent structure, the absorbent structure being a honeycomb structure, the honeycomb structure being characterized by parameters, the parameters being chosen so that the absorbent structure provides an attenuation of at least 10 dB for each incident wave in a frequency range having a frequency spread greater than or equal to 15 GHz, the method comprising the steps of:
printing strips of electrically conductive coating,
depositing a layer of adhesive over a surface of at least one wafer of dielectric material,
bonding the wafers over the layers of adhesive,
assembling the wafers for forming a plurality of tubular cells, each cell including a plurality of walls delimiting said cell, the walls extending from a first end face to a second end face of the honeycomb structure extending between a first end face and a second end face,
expanding the assembled wafers, so to obtain a structure to stiffen, and
curing the structure to be stiffen, so as to obtain the final honeycomb structure.

12. A method of optimizing an absorbent structure, the absorbent structure being a honeycomb structure extending between a first end face and a second end face, the honeycomb structure comprising a plurality of tubular cells, each cell having a plurality of walls defining said cell, the walls extending from the first end face to the second end face, the walls being formed from a dielectric material, at least one cell including at least one strip of electrically conductive coating arranged in at least one wall or over a surface of at least one wall, the honeycomb structure being characterized by parameters, the method including a step of:
choice of initial parameters for the honeycomb structure, and
optimization of the parameters of the honeycomb structure according to an optimization technique implemented by successive iterations on sets of current parameters, the first set of parameters being the set of initial parameters and the set of parameters of an iteration being the set of parameters obtained at the previous iteration, the optimization technique being implemented under the requirement that the absorbent structure (20) provides an attenuation of at least 10 dB for each incident wave in a frequency range having a frequency spread greater than or equal to 15 GHz.

13. A computer program product including a readable storage medium on which is stored a computer program comprising program instructions, the computer program being loadable on a data processing unit and implementing an optimization method according to the claim 12 when the computer program is implemented on the data processing unit.

14. A readable storage medium including program instructions forming a computer program, the computer program being loadable on a data processing unit and implementing an optimization method according to claim 12 when the computer program is implemented on the data processing unit.
